(19) United States
(12) Patent Application Publication
(10) Pub. No.: US 2020/0391525 A1
(43) Pub. Date: Dec. 17, 2020

(54) PRINTER

(71) Applicant: Mitsubishi Electric Corporation, Tokyo (JP)

(72) Inventor: Masatomo SAKAGUCHI, Tokyo (JP)

(73) Assignee: Mitsubishi Electric Corporation, Tokyo (JP)

(21) Appl. No.: 16/971,960

(22) PCT Filed: Apr. 25, 2018
(86) PCT No.: PCT/JP2018/016744

§ 371 Date: Aug. 21, 2020

(51) Int. Cl. B41J 11/70; B41J 17/02; B41J 2/325

(52) U.S. Cl. CPC B41J 11/706; B41J 2/325; B41J 17/02

(57) ABSTRACT

Provided is a printer having a simple structure, which is low in cost, and capable of improving cutting accuracy of the printed paper and improving the quality of an output printed object. A bobbin drive unit generates a driving force that rotationally drives a bobbin on which an ink sheet is wound. A thermal head heats an ink sheet and performs thermal transfer from the ink sheet to paper delivered from a roll of paper and produces printed paper. The fixed blade extends in a width direction of the printed paper. The movable blade is arranged along the fixed blade, moves in the width direction, and cuts the printed paper. A movable blade drive unit drives the movable blade. A pressing mechanism includes a transport roller and a pressing roller. The transport roller is rotationally driven by the above driving force.

### TECHNICAL FIELD

The present invention relates to a printer.

### BACKGROUND ART

A thermal transfer printer using a roll of paper which outputs a printed object having a set size includes an ink sheet, a thermal head, and a cutter.

The roll of paper is recording paper wound in a roll shape (hereinafter, referred to as “paper”). Paper to be subjected to printing is sent out from the roll of paper.

The ink sheet has a plurality of printing surfaces in which each of the yellow (Y) ink dye, the magenta (M) ink dye, the cyan (C) ink dye, and the OP material that constitutes the overcoat (OP) for protecting the surface to be printed of the paper is coated.

The thermal head heats the ink sheet. Thus, the Y, M, and C ink dyes and the

OP material are thermally transferred from the ink sheet to the paper, and the images of Y, M, and C, and the OP are overlaid on the paper, and printed paper having a printed surface whose size coincides with the size of the printing surface of the ink sheet is produced.

The cutter cuts the produced printed paper. As a result, a printed object having the set size is produced. The produced printed object is output from the thermal transfer printer. The printed paper is cut by a movable blade that moves in the width direction of the printed paper, which is perpendicular to the direction in which the printed paper is output.

With the combination of the size of the paper and the size of the printing surface of the ink sheet, and by adjusting the cutting position of the paper in accordance with the size of the surface to be printed of the paper, the thermal transfer printer can output printing objects having a variety of sizes. In addition, with the width of the printing surface of the ink sheet which is wider than the width of the paper and by separating the margins of the paper when cutting the produced printed paper, the thermal transfer printer can also output a frameless printed object with no margins.

In the thermal transfer printer, the quality of the printed object to be output is affected by the cutting accuracy, and is strongly influenced by the accuracy of the cutting position and the straightness of the cutting. Therefore, the thermal transfer printer is required to be improved in cutting accuracy, and it is strongly required to improve the accuracy of the cutting position and the straightness of the cutting. Therefore, in the thermal transfer printer, in order to improve the accuracy of the cutting position, it has been attempted to reduce the looseness and inclination of the printed paper to stabilize the cutting position. Further, in order to improve the straightness of cutting, it has been attempted to reduce the fluctuation in the cutting time.

For example, in a thermal printer described in Patent Document 1, the recording medium is pressed by the pressing roller and the transport roller when the recording medium is cut (paragraphs 0016 and 0026). This prevents the recording medium from being cut in an oblique manner with respect to the width direction (paragraph 0025).

In the thermal printer described in Patent Document 2, the halfway moving time from when the rotary blade is detected by the left standby position sensor to when the rotary blade is detected by the intermediate position sensor is measured, and the moving speed of the rotary blade after being detected by the intermediate position sensor is controlled based on the deviation between the measured halfway moving time and the reference value (paragraphs 0013 and 0019). As a result, when the cutting resistance of the recording paper changes, fluctuations in the entire moving time of the rotary blade during cutting are suppressed (paragraph 0023).

Improving the accuracy of the cutting position is particularly significant when cutting the printed paper having a large thickness. This is because when the printed paper having a large thickness is cut, the driving torque of the movable blade becomes large, so that the printed paper is likely to become unstable due to a shock at the time of cutting and the accuracy of the cutting position is likely to decrease.

Further, in the thermal transfer printer, it is required to shorten the cutting time. Particularly, in a thermal transfer printer that outputs a printed object having a large size, it is strongly required to shorten the cutting time. In a thermal transfer printer that outputs a printed object having a large size, shortening of the cutting time is strongly required. This is because, in a thermal transfer printer, a paper transport path is arranged so that the paper stays inside the thermal transfer printer during printing in order to suppress deterioration in the quality of the print due to dust and the like adhering during printing, and, in a thermal transfer type printer that outputs a printed object having a large size, the distance from the printing mechanism including the thermal head, the main transport roller and the like to the cutter becomes long.

### PRIOR ART DOCUMENTS

### Patent Documents

[Patent Document 1] Japanese Patent Application Laid-Open No. 2011-93257

[Patent Document 2] Japanese Patent Application Laid-Open No. 2013-107259

### SUMMARY

### Problem to be Solved by the Invention

In the above-mentioned thermal transfer type printer, in order to improve the accuracy of the cutting position, a dedicated drive unit that rotationally drives the transport roller is required to be provided. Therefore, the structure of the thermal transfer printer becomes complicated, and the cost of the thermal transfer printer increases.

The present invention has been made in view of these problems. The problems to be solved by the present invention is to provide a printer having a simple structure, which is low in cost, improves the cutting accuracy of the printed paper, and improve the quality of an output printed object.

### Means to Solve the Problem

The printer includes a bobbin drive unit, a thermal head, a fixed blade, a movable blade, and a pressing mechanism.

The bobbin drive unit generates a driving force that rotationally drives a bobbin on which an ink sheet is wound.

The thermal head heats the ink sheet and performs thermal transfer from the ink sheet to paper delivered from a roll of paper and produces printed paper.

The fixed blade extends in a width direction of the printed paper.

The movable blade is arranged along the fixed blade, moves in the width direction, and cuts the printed paper.

A movable blade drive unit drives the movable blade.

A pressing mechanism includes a transport roller and a pressing roller. The transport roller is rotationally driven by the above driving force. In a pressing mechanism, the pressing roller presses the printed paper toward the transport roller before the movable blades starts cutting the printed paper. The pressing mechanism removes looseness from the printed paper before the movable blade starts cutting the printing paper.

### Effects of the Invention

In the present invention, a transport roller is rotationally driven by a driving force that rotationally drives a bobbin on which an ink sheet is wound, and a pressing roller presses printed paper toward the transport roller before the movable blades starts cutting the printed paper. Therefore, the looseness of the printed paper can be removed before the cutting of the printed paper is started without providing a dedicated drive unit that rotationally drives the transport roller. Accordingly, the printer having a simple structure, which is low in cost, and capable of improving the accuracy of the cutting position can be provided. Therefore, the printer having a simple structure, which is low in cost, and capable of improving the cutting accuracy of the printed paper and improving the quality of the printed object to be output, can be provided.

The explicit purpose, feature, phase, and advantage of the present invention will be described in detail hereunder with attached drawings.

### BRIEF DESCRIPTION OF DRAWINGS

FIG. 1 A side view schematically illustrating a printer of Embodiment 1.

FIG. 2 A perspective view schematically illustrating a state in which a cutting mechanism included in the printer according to Embodiment 1 is viewed from an oblique back side.

FIG. 3 A perspective view schematically illustrating a state in which the cutting mechanism included in the printer according to Embodiment 1 is viewed from an oblique front side.

FIG. 4 A perspective view schematically illustrating a state in which the cutting mechanism and an ink sheet driving mechanism included in the printer according to Embodiment 1 is viewed from an oblique front side.

FIG. 5 A perspective view schematically illustrating a state in which the cutting mechanism and the ink sheet driving mechanism included in the printer according to Embodiment 1 is viewed from an oblique back side.

FIG. 6 A block diagram illustrating a control system of the printer according to Embodiment 1.

FIGS. 7A and 7B Top views schematically illustrating an operating position of the movable blade and a positional relationship of the printed paper when the movable blade provided in the printer according to Embodiment 1 cuts the printed paper.

FIGS. 8A to 8D Diagrams schematically illustrating a state in which the cutting mechanism included in the printer according to Embodiment 1.

FIGS. 9A and 9B Graphs illustrating a relationship between a position of the movable blade included in the printer according to Embodiment 1 in the width direction of the printed paper and the driving torque generated by the DC motor included in the movable blade drive unit of the printer.

FIG. 10 A flowchart illustrating the flow of the overall operation of the printer according to Embodiment 1.

FIG. 11 A flowchart illustrating the flow of the overall operation of the printer according to Embodiment 1.

FIGS. 12A to 12D Diagrams schematically illustrating a state in which the cutting mechanism included in the printer according to Modification of Embodiment 1.

### DESCRIPTION OF EMBODIMENT(S)

1 Outline of Printer

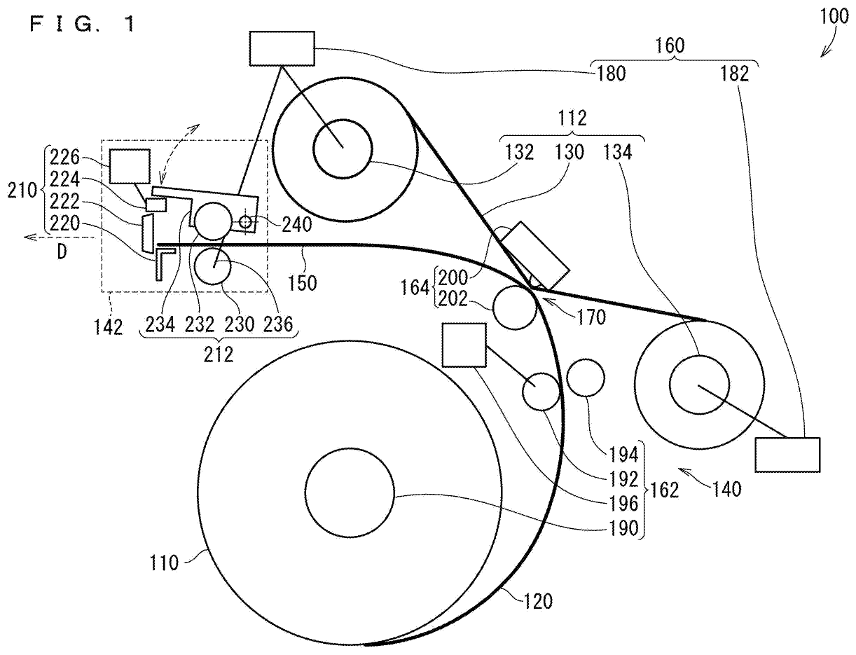

FIG. 1 is a side view schematically illustrating a printer of Embodiment 1.

A printer 100 illustrated in FIG. 1 is a thermal transfer printer.

A roll of paper 110 and an ink cassette 112 are attached to the printer 100.

The roll of paper 110 includes paper 120 wound in a roll shape.

The ink cassette 112 includes an ink sheet 130, an unwinding (SP) side bobbin 132, and a winding (TU) side bobbin 134. The ink sheet 130 includes a sheet-shaped substrate. Yellow (Y), magenta (M), and cyan (C) ink dyes are applied to the sheet-shaped substrate, and an OP material that constitutes an overcoat (OP) that protects the surface to be printed is applied. The combination of Y, M, and C may be replaced with other multiple color combinations. The application of the OP material may be omitted. The ink sheet 130 is wound around the SP side bobbin 132 and the TU side bobbin 134, connecting the SP side bobbin 132 and the TU side bobbin 134.

The printer 100 includes a printing mechanism 140 and a cutting mechanism 142. The printer 100 may include elements other than these elements.

The printing mechanism 140 prints on the paper 120 delivered from the roll of paper 110 by a thermal transfer method. As a result, a printed paper 150 is produced.

The cutting mechanism 142 cuts the produced printed paper 150. As a result, a printed object having the set size is produced. The produced printed object is output from the printer 100.

2 Printing Mechanism

The printing mechanism 140 includes an ink sheet driving mechanism 160, a paper transporting mechanism 162, and a thermal transferring mechanism 164, as illustrated in FIG. 1. The printing mechanism 140 may include elements other than these elements.

The ink sheet driving mechanism 160 drives the SP side bobbin 132 and the TU side bobbin 134 so that the ink sheet 130 sent out from the SP side bobbin 132 is wound around the TU side bobbin 134.

The paper transporting mechanism 162 transports the paper 120 along a paper transport path that reaches the cutting mechanism 142 via the thermal transfer position 170. The paper 120 is superposed on the ink sheet 130 at the thermal transfer position 170.

The thermal transferring mechanism 164 thermally transfers the Y, M, and C ink dyes and the OP material from the ink sheet 130 to the paper 120 at the thermal transfer position 170. As a result, a printing surface on which the Y, M, and C images are superimposed is formed on the paper 120 and an OP that protects the printing surface is formed, and the printed paper 150 is produced.

3 Ink Sheet Driving Mechanism

As illustrated in FIG. 1, the ink sheet driving mechanism 160 includes an SP side bobbin drive unit 180 and a TU side bobbin drive unit 182. The ink sheet driving mechanism 160 may include elements other than these elements.

The SP side bobbin drive unit 180 includes a drive source such as a direct current (DC) motor. The SP side bobbin drive unit 180 generates a driving force that rotationally drives the SP side bobbin 132. Accordingly, the SP side bobbin 132 rotates, and the ink sheet 130 is sent out from the SP side bobbin 132. The SP side bobbin drive unit 180 also generates a driving force for rotationally driving the SP side bobbin 132 in a rotation direction opposite to the rotation direction in which the ink sheet 130 is sent out. Accordingly, the set tension is applied to the ink sheet 130.

The TU side bobbin drive unit 182 includes a drive source such as a DC motor. The TU side bobbin drive unit 182 generates a driving force that rotationally drives the

TU side bobbin 134. Accordingly, the TU side bobbin 134 rotates, and the ink sheet 130 is wound around the TU side bobbin 134.

4 Paper Transporting Mechanism

As illustrated in FIG. 1, the paper transporting mechanism 162 includes a rolled paper rotation drive unit 190, a main transport roller 192, a pinch roller 194, and a paper main transport unit 196. The paper transporting mechanism 162 may include elements other than these elements.

The rolled paper rotation drive unit 190 rotationally drives the roll of paper 110 rotatably held by a holding mechanism (not illustrated). Accordingly, the roll of paper 110 rotates and the paper 120 is sent out from the roll of paper 110. Further, the rolled paper rotation drive unit 190 rotationally drives the roll of paper 110 in a rotation direction opposite to the rotation direction in which the paper 120 is sent out. Accordingly, the roll of paper 110 rotates and the paper 120 is wound around the roll of paper 110.

The main transport roller 192 and the pinch roller 194 nip the paper 120.

The paper main transport unit 196 includes a drive source such as a stepping motor. The paper main transport unit 196 rotationally drives the main transport roller 192. Accordingly, the main transport roller 192 rotates, the nipped paper 120 is sent out, and the paper 120 is transported along the paper transport path reaching the cutting mechanism 142 via the thermal transfer position 170.

5 Thermal Transferring Mechanism

The thermal transferring mechanism 164 includes a thermal head 200 and a platen roller 202, as illustrated in FIG. 1. The thermal transferring mechanism 164 may include elements other than these elements.

The thermal head 200 and the platen roller 202 are opposed to each other with the thermal transfer position 170 sandwiched therebetween, and the ink sheet 130 and the paper 120 that have been overlapped are pressure bonded.

The thermal head 200 heats the ink sheet 130. As a result, the Y, M, and C ink dyes and the OP material are thermally transferred from the ink sheet 130 to the paper 120, and the printed paper 150 is produced.

6 Cutting Mechanism

The cutting mechanism 142 includes a cutter 210 and a pressing mechanism 212, as illustrated in FIG. 1. The cutting mechanism 142 may include elements other than these elements.

The cutter 210 cuts the printed paper 150.

When the cutter 210 cuts the printed paper 150, the pressing mechanism 212 presses the printed paper 150 to remove the looseness in the printed paper 150. This improves the accuracy of the cutting position when the cutter 210 cuts the printed paper 150. The pressing mechanism 212 has already pressed the printed paper 150 before the cutter 210 starts cutting the printed paper 150. Accordingly, with the pressing mechanism 212, the looseness in the printed paper 150 can be removed before the cutter 210 starts cutting the printed paper 150.

7 Cutter

As illustrated in FIG. 1, the cutter 210 includes a fixed blade 220, a movable blade 222, a carriage 224, and a movable blade drive unit 226. The cutter 210 may include elements other than these elements.

The fixed blade 220 is arranged along the paper transport path and extends in the width direction of the printed paper 150 which is perpendicular to the transport direction of the printed paper 150 and the output direction D of the printed object.

The movable blade 222 is a rotary blade. The movable blade 222 is arranged along the fixed blade 220, moves in the width direction of the printed paper 150, and cuts the printed paper 150.

The carriage 224 holds the movable blade 222. The main part of the movable blade 222 is housed inside the carriage 224.

The movable blade drive unit 226 includes a drive source such as a DC motor. The movable blade drive unit 226 drives the carriage 224 to integrally drive the movable blade 222 and the carriage 224. As a result, the movable blade 222 and the carriage 224 integrally move in the width direction of the printed paper 150.

8 Pressing Mechanism

As illustrated in FIG. 1, the pressing mechanism 212 includes a transport roller 230, a pressing roller 232, a holding metal plate 234, and a transmission mechanism 236.

The transport roller 230 and the pressing roller 232 are opposed to each other with the printed paper 150 sandwiched therebetween. The transport roller 230 is arranged on the back side of the printed paper 150. The pressing roller 232 is arranged on the printing surface side of the printed paper 150.

The holding metal plate 234 serves as a holding part that holds the pressing roller 232. The holding part made of the holding metal plate 234 may be replaced with a holding part made of a part other than the holding metal plate 234.

The holding metal plate 234 rotates about the rotation center 240 and moves between the open position and the closed position. FIG. 1 illustrates a state in which the holding metal plate 234 is at the open position.

When the holding metal plate 234 is at the open position, the pressing roller 232 is away from the transport roller 230, and the pressing mechanism 212 is open. When the pressing mechanism 212 is open, the pressing roller 232 does not press the printed paper 150 toward the transport roller 230, the pressing mechanism 212 does not press the printed paper 150, and the printed paper 150 is released.

When the holding metal plate 234 is at the closed position, the pressing roller 232 is brought close to the transport roller 230, and the pressing mechanism 212 is closed. When the pressing mechanism 212 is closed, the pressing roller 232 presses the printed paper 150 toward the transport roller 230, and the pressing mechanism 212 presses the printed paper 150.

The cutting mechanism 142 is arranged close to the SP side bobbin drive unit 180. The transmission mechanism 236 transmits the driving force generated by the SP side bobbin drive unit 180 from the SP side bobbin drive unit 180 to the transport roller 230. Accordingly, the transport roller 230 is rotationally driven by the driving force generated by the SP side bobbin drive unit 180, and the transport roller 230 rotates. The looseness in the printed paper 150 is removed by rotating the transport roller 230 in a state where the pressing mechanism 212 holds the printed paper 150.

In the printer 100, the transport roller 230 is rotationally driven by the driving force that rotationally drives the SP side bobbin 132 on which the ink sheet 130 is wound, and the pressing roller 232 presses the printed paper 150 toward the transport roller 230 before the movable blade 222 starts cutting the printed paper 150. Therefore, the looseness in the printed paper 150 can be removed before the cutting of the printed paper 150 is started without providing a dedicated drive unit for rotationally driving the transport roller 230. Accordingly, the printer 100 having a simple structure, which is low in cost, and capable of improving the accuracy of the cutting position can be provided. Therefore, the printer 100 having a simple structure, which is low in cost, and capable of improving the cutting accuracy of the printed paper 150 and improving the quality of the printed object to be output, can be provided.

Further, in the printer 100, the driving force generated by the SP side bobbin drive unit 180 arranged close to the cutting mechanism 142 is transmitted to the transport roller 230. Therefore, the structure of the transmission mechanism 236 can be simplified as compared with the case where the driving force generated by the paper main transport unit 196 arranged not close to the cutting mechanism 142 is transmitted to the transport roller 230. For example, the number of gears included in a gear train 332 described later can be reduced.

Further, in the printer 100, the transport roller 230 that is rotationally driven is arranged on the back side of the printed paper 150. Therefore, even when a layout having a short paper transport path that reaches the transport roller 230 with which the printed paper 150 is rotationally driven in the middle of printing is adopted, outputting a printed object having high quality is ensured without the transport roller 230 that is rotationally driven rubbing the printed side of the printed paper 150.

The transport roller 230 may be rotationally driven to transport the printed paper 150 when the printed paper 150 is cut. The transport roller 230 may be rotationally driven in order to output a printed object produced by cutting the printed paper 150 from the printer 100. In this case, the transport roller 230 is used as a paper discharge roller, this ensures to reduce the number of transport rollers arranged along the paper transport path and simplify the mechanism provided in the printer 100.

9 Details of Cutting Mechanism

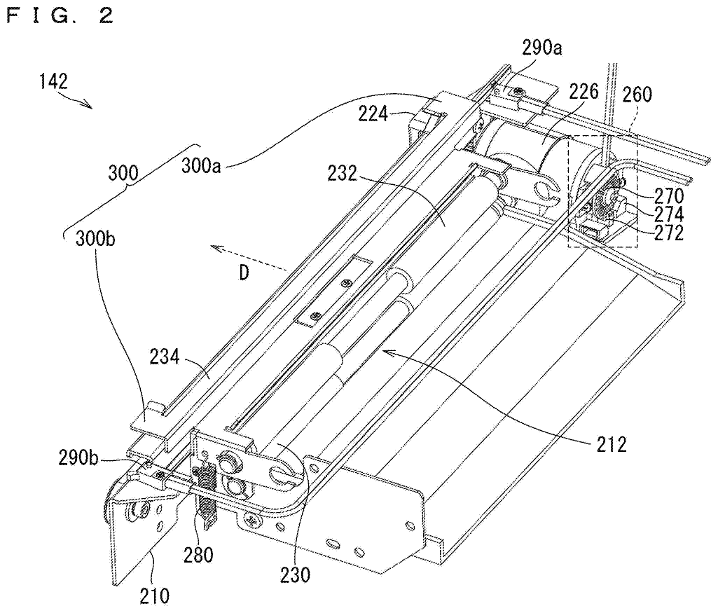

FIG. 2 is a perspective view schematically illustrating a state in which a cutting mechanism included in the printer according to Embodiment 1 is viewed from an oblique back side. In FIG. 2, a paper guide described later is omitted.

In FIG. 2, the cutter 210 and the pressing mechanism 212 described above are illustrated, the carriage 224 and the movable blade drive unit 226 described above are illustrated, and the transport roller 230, the pressing roller 232, and the holding metal plate 234 described above are illustrated.

Further, in FIG. 2, a rotation sensor 260 included in the cutter 210 is illustrated, and a rotary encoder 270, an optical transmission sensor 272, and a pulse counting unit 274 included in the rotation sensor 260 are illustrated.

The rotation sensor 260 detects the rotation amount of the rotary shaft of the movable blade drive unit 226. The rotation amount of the rotary shaft of the movable blade drive unit 226 is proportional to the moving distance of the movable blade 222. Therefore, the rotation sensor 260 is used as a distance sensor that detects the moving distance of the movable blade 222. A sensor other than the rotation sensor 260 may be used as the distance sensor.

The rotary encoder 270 is coupled to the rotary shaft of the movable blade drive unit 226 and rotates integrally with the rotary shaft of the movable blade drive unit 226. The rotary encoder 270 has a plate-like shape and has a main surface perpendicular to the direction in which the rotation shaft extends. A slit is formed in the rotary encoder 270.

The optical transmission sensor 272 includes a light emitting unit and a light receiving unit that are opposed to each other with the rotary encoder 270 interposed therebetween, and the slit passes between the light emitting unit and the light receiving unit, and outputs a pulse when the light emitted by the light emitting unit is received by the light receiving unit.

The pulse counting unit 274 is electrically connected to the optical transmission sensor 272 and counts the pulses output by the optical transmission sensor 272.

Further, FIG. 2 illustrates a tension spring 280 provided in the pressing mechanism 212.

The tension spring 280 urges the holding metal plate 234 in a direction from the open position to the closed position. As described above, when the holding metal plate 234 is at the open position, the pressing roller 232 is kept away from the transport roller 230, and when the holding metal plate 234 is at the closed position, the pressing roller 232 is brought close to the transport roller 230, and thus the printed paper 150 is pressed toward the transport roller 230. Therefore, the tension spring 280 generates a force that pushes the pressing roller 232 toward the transport roller 230 by urging the holding metal plate 234 in the direction from the open position to the closed position. The tension spring 280 may be replaced with an elastic body other than the tension spring 280. For example, the tension spring 280 may be replaced with a compression spring, a torsion-coil spring, a leaf spring, an air spring, a rubber cord, or the like.

In addition, in FIG. 2, a standby position sensor 290a and a standby position sensor 290b included in the cutter 210 are illustrated, and an arm 300a and an arm 300b provided on the holding metal plate 234 are illustrated. The description thereof will be made below.

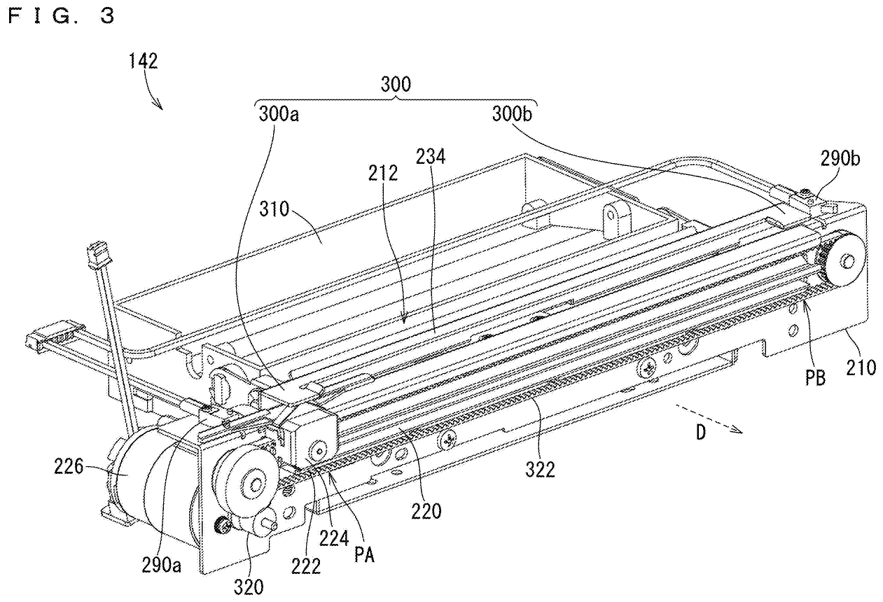

FIG. 3 is a perspective view schematically illustrating a state in which the cutting mechanism included in the printer according to Embodiment 1 is viewed from an oblique front side.

In FIG. 3, the cutter 210 and the pressing mechanism 212 described above are illustrated, the movable blade 222, the carriage 224, and the movable blade drive unit 226 described above are illustrated, and the holding metal plate 234 described above is illustrated.

Further, FIG. 3 illustrates the paper guide 310 provided in the cutting mechanism 142.

The holding metal plate 234 is rotatably held by a shaft portion provided in the paper guide 310. As a result, the holding metal plate 234 can rotate about the rotation center 240 passing through the center of the shaft portion provided in the paper guide 310.

Further, FIG. 3 illustrates a gear 320, a belt 322, and the like included in the movable blade drive unit 226.

The carriage 224 is movably held in the cutter 210, and is moved in the width direction of the printed sheet 150 by a movable blade drive unit 226 including the gear 320, the belt 322, and the like.

Further, in FIG. 3, the arm 300a and the arm 300b provided on the holding metal plate 234 are illustrated.

The arm 300a and the arm 300b are provided on the standby position PA and the standby position PB, respectively. The standby position PA is one movable end of the movable range of the movable blade 222 and the carriage 224. The standby position PB is the other movable end of the movable range of the movable blade 222 and the carriage 224. The standby position PA may be at a position other than one movable end. The standby position PB may be at a position other than the other movable end. However, the standby position PA and the standby position PB must be positions that are deviated from the printed paper 150.

The arm 300a and the arm 300b each form a contact portion 300 that contacts the carriage 224 when the movable blade 222 and the carriage 224 are at the standby position PA and the standby position PB.

The carriage 224 contacts the contact portion 300 when the movable blade 222 and the carriage 224 are at the standby position PA or the standby position PB, and pushes and moves the contact portion 300 withstanding the force generated by the tension spring 280. The direction in which the contact portion 300 is pushed and moved is the direction in which the movement that the pressing roller 232 is moved away from the transport roller 230 is generated. Accordingly, the printed paper 150 is not pressed by the pressing mechanism 212 when the movable blade 222 and the carriage 224 are at the standby position PA or the standby position PB, and the printed paper 150 is pressed by the pressing mechanism 212 when the movable blade 222 and the carriage 224 are not at the standby position PA or the standby position PB.

The standby position PA or the standby position PB is a position deviated from the printed paper 150. Therefore, while the movable blade 222 and the carriage 224 are over the printed paper 150 and the movable blade 222 is cutting the printed paper 150, the pressing mechanism 212 presses the printed paper 150. The arm 300a and the arm 300b are not extended over the printed paper 150. As a result, the pressing mechanism 212 presses the printed paper 150 before the movable blade 222 starts cutting the printed paper 150.

Further, FIG. 3 illustrates the standby position sensor 290a and the standby position sensor 290b provided in the cutter 210.

The standby position sensor 290a and the standby position sensor 290b each detect that the movable blade 222 and the carriage 224 are at the standby position PA and the standby position PB, respectively.

In the printer 100, after the standby position sensor 290a detects that the movable blade 222 and the carriage 224 are at the standby position PA, the position of the movable blade 222 and the position of the carriage 224 in the width direction of the printed paper 150 are specified from the moving distance detected by the distance sensor 260. Therefore, the standby position sensor 290b can be omitted. Alternatively, after the standby position sensor 290b detects that the movable blade 222 and the carriage 224 are at the standby position PB, the position of the movable blade 222 and the position of the carriage 224 in the width direction of the printed paper 150 are specified from the moving distance detected by the distance sensor 260 and in such a case, the standby position sensor 290a can be omitted. Therefore, in the printer 100, one of the standby position sensor 290a and the standby position sensor 290b can be omitted.

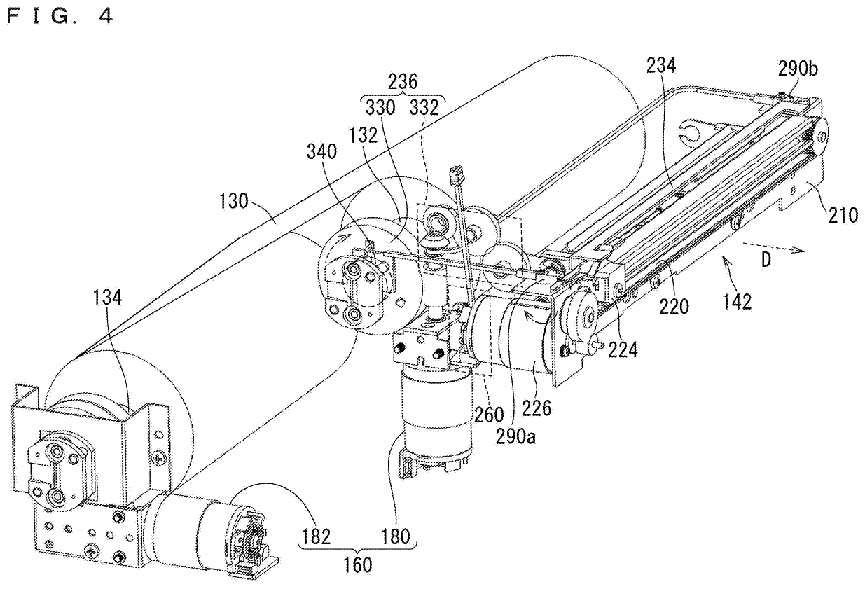

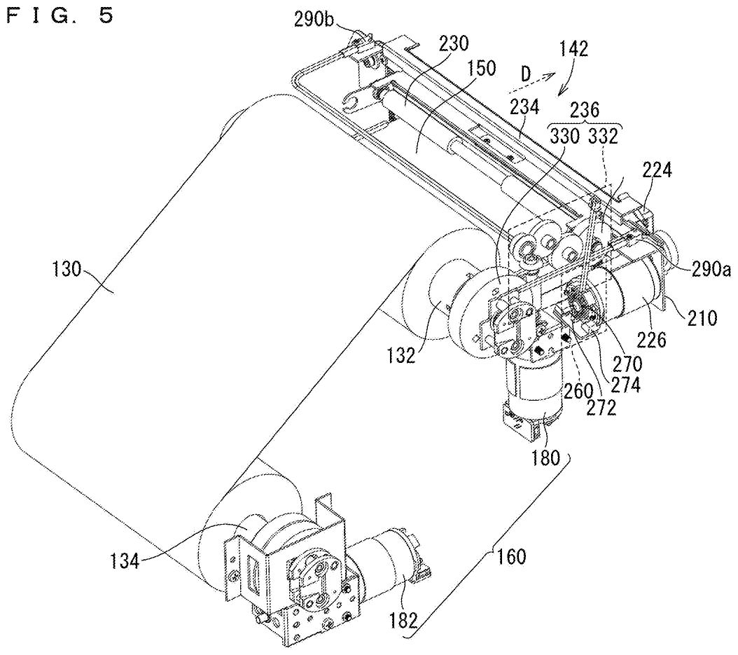

FIG. 4 is a perspective view schematically illustrating a state in which the cutting mechanism and an ink sheet driving mechanism included in the printer according to Embodiment 1 is viewed from an oblique front side. FIG. 5 is a perspective view schematically illustrating a state in which the cutting mechanism and the ink sheet driving mechanism included in the printer according to Embodiment 1 is viewed from an oblique back side.

In FIG. 4 and FIG. 5 the transmission mechanism 236 described above is illustrated, and the gear 330 and the gear train 332 included in the transmission mechanism 236 are illustrated. FIG. 4 illustrates a torque limiter 340 included in the gear 330.

The gear 330 is connected to the SP side bobbin 132.

The gear train 332 is driven by the gear 330.

As a result, the driving force generated by the SP side bobbin drive unit 180 is transmitted to the transport roller 230, the transport roller 230 is rotationally driven by the transmitted drive force, and the transport roller 230 rotates.

The torque limiter 340 may be replaced with a mechanism such as a one-way clutch or a swinging idler.

10 Control System

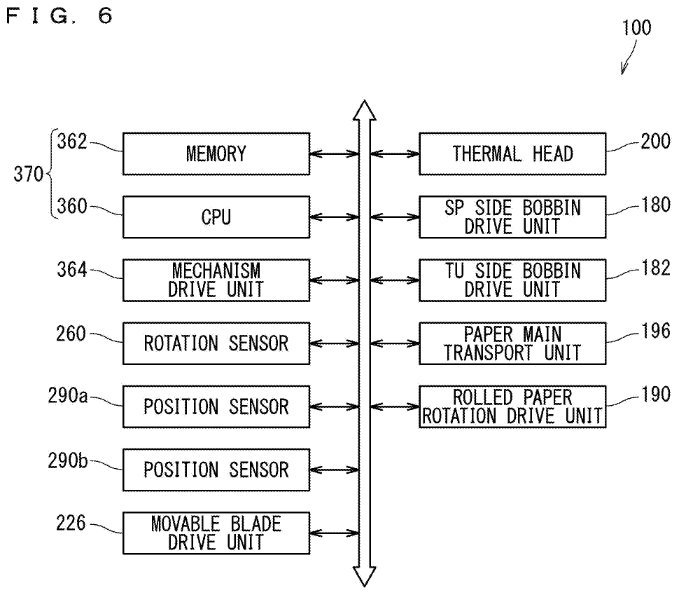

FIG. 6 is a block diagram illustrating a control system of the printer according to Embodiment 1.

In FIG. 6, the SP side bobbin drive unit 180, the TU side bobbin drive unit 182, the rolled paper rotation drive unit 190, the paper main transport unit 196, the thermal head 200, the movable blade drive unit 226, the rotation sensor 260, the standby position sensor 290a, and the standby position sensor 290b described above are illustrated.

In addition, FIG. 6 illustrates a CPU 360, a memory 362, and a mechanism drive unit 364 included in the printer 100.

The CPU 360 and the memory 362 constitute a computer, constituting a control unit 370 that controls the overall operation of the printer 100. The CPU 360 executes the control program stored in the memory 362, and controls the overall operation of the printer 100 according to the control program. In controlling the overall operation of the printer 100, the detection results of the rotation sensor 260, the standby position sensor 290a, and the standby position sensor 290b are acquired, and the SP side bobbin drive unit 180, the TU side bobbin drive unit 182, and the rolled paper rotation drive unit 190, the paper main transport unit 196, the thermal head 200, and the movable blade drive unit 226 are controlled. All or part of the processing performed by the control unit 370 that is a computer may be performed by hardware that is not a computer.

The memory 362 includes a non-volatile memory such as a flash memory and a volatile memory such as a random access memory (RAM). The non-volatile memory serves as a storage unit that stores a control program and specified data. The specified data includes types of the attached ink sheet 130 and paper 120, control data, and the like. The type of paper 120 includes the width and thickness of the paper 120. The control data includes a driving torque value and the like. The volatile memory serves as a storage unit that temporarily stores data related to control of the mechanism driving unit 364 and printing processing. The width and thickness of the paper 120 may be stored in a storage unit that is not a memory. For example, the width and thickness of the paper 120 may be stored in a hard disk drive.

11 Positional Relationship Between Each Movable Blade Operating Position and Printed Paper

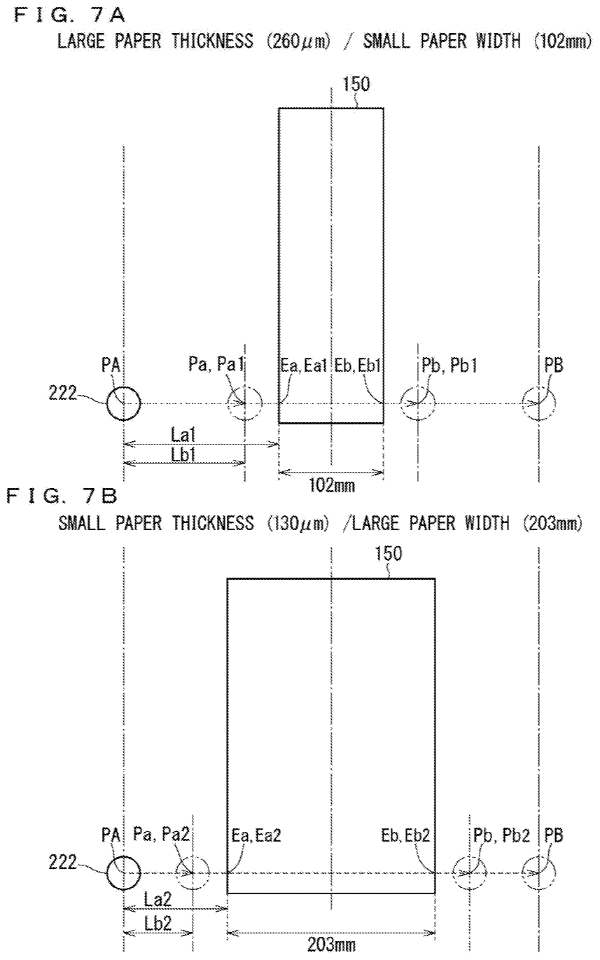

FIGS. 7A and 7B are top views schematically illustrating an operating position of the movable blade and a positional relationship of the printed paper when the movable blade provided in the printer according to Embodiment 1 cuts the printed paper. FIG. 7A is a top view illustrating the positional relationship when the thickness of the printed paper is 260 μm and the width of the printed paper is 102 mm. FIG. 7B is a top view illustrating the positional relationship when the thickness of the printed paper is 130 μm and the width of the printed paper is 203 mm.

When the movable blade 222 cuts the printed paper 150, the movable blade 222 and the carriage 224 reciprocate between the standby position PA and the standby position PB.

In the forward path as illustrated in FIGS. 7A and 7B, the movable blade 222 and the carriage 224 move from the standby position PA to the standby position PB sequentially passing through a stop position Pa, one widthwise end portion Ea of the printed paper 150, the other widthwise end portion Eb of the printed paper 150, and a stop position Pb.

In the return path, the movable blade 222 and the carriage 224 move from the standby position PB to the standby position PA sequentially passing through a stop position Pb, the other widthwise end portion Eb of the printed paper 150, the one widthwise end portion Ea of the printed paper 150, and a stop position Pa.

The stop position Pa and the stop position Pb are the positions where braking for stopping the movable blade 222 and the carriage 224 is started. The printed paper 150 locates between the stop position Pa and the stop position Pb. On the forward path, the movable blade 222 contacts the printed paper 150 and cuts the printed paper 150 while moving from the stop position Pa to the stop position Pb. On the return path, the movable blade 222 contacts the printed paper 150 and cuts the printed paper 150 while moving from the stop position Pb to the stop position Pa.

The stop position Pa, one widthwise end portion Ea of the printed paper 150, the other widthwise end portion Eb of the printed paper 150, and the stop position Pb change according to the width of the printed paper 150. For example, the stop position Pa is Pa1 as illustrated in FIG. 7A when the width of the printed paper 150 is 102 mm, and when the width of the printed paper 150 is 203 mm, the stop position Pa is Pa2 which is different from Pal as illustrated in FIG. 7B. Also, the one widthwise end portion Ea is Ea1 as illustrated in FIG. 7A when the width of the printed paper 150 is 102 mm, and when the width of the printed paper 150 is 203 mm, the one widthwise end portion Ea is Ea2 which is different from Ea1 as illustrated in FIG. 7B. Also, the other widthwise end portion Eb is Eb1 as illustrated in FIG. 7A when the width of the printed paper 150 is 102 mm, and when the width of the printed paper 150 is 203 mm, the other widthwise end portion Eb is Eb2 which is different from Eb1 as illustrated in FIG. 7B. Also, the stop position Pb is Pb1 as illustrated in FIG. 7A when the width of the printed paper 150 is 102 mm, and when the width of the printed paper 150 is 203 mm, the stop position Pb is Pb2 which is different from Pb1 as illustrated in FIG. 7B.

Therefore, the distance La from the standby position PA to the one widthwise end portion Ea of the printed paper 150, the distance Lb from the standby position PA to the stop position Pa, the distance from the standby position PB to the other widthwise end portion Eb of the printed paper 150, and the distance from the standby position PB to the stop position Pb change according to the width of the printed paper 150. For example, the distance La is La1 as illustrated in FIG. 7A when the width of the printed paper 150 is 102 mm, and when the width of the printed paper 150 is 203 mm, La is La2 which is different from La1 as illustrated in FIG. 7B. Also, the distance Lb is Lb1 as illustrated in FIG. 7A when the width of the printed paper 150 is 102 mm, and when the width of the printed paper 150 is 203 mm, Lb is Lb2 which is different from Lb1 as illustrated in FIG. 7B.

12 State of Cutting Mechanism When Movable Blade Is At Each Operating Position

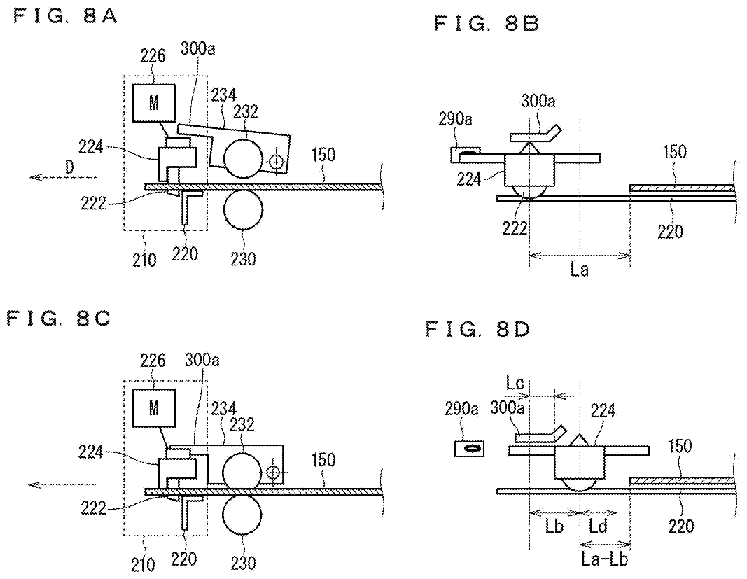

FIGS. 8A to 8D are diagrams schematically illustrating a state in which the cutting mechanism included in the printer according to Embodiment 1. FIGS. 8A and 8B are diagrams illustrating a state of the main part of the cutting mechanism when the movable blade and the carriage are at the standby position. FIG. 8A is a side view. FIG. 8B is a front view. FIGS. 8C and 8D are diagrams illustrating a state of the main part of the cutting mechanism when the movable blade and the carriage are at the stop position. FIG. 8C is a side view. FIG. 8D is a front view.

When the movable blade 222 and the carriage 224 are at the standby position PA, as illustrated in FIGS. 8A and 8B, the carriage 224 contacts the arm 300a, pushes up the arm 300a, and pushes up the holding metal plate 234 including the arm 300a to the open position. Accordingly, the pressing roller 232 is moved away from the transport roller 230, and a gap larger than the thickness of the printed paper 150 is formed between the transport roller 230 and the pressing roller 232. When the movable blade 222 and the carriage 224 are at the standby position PB, the same state is also realized except that the carriage 224 contacts the arm 300b.

When the movable blade 222 and the carriage 224 move from the standby position PA to the stop position Pa, as illustrated in FIGS. 8C and 8D, the contact between the carriage 224 and the arm 300a is released, the force generated by the tension spring 280 lowers the arm 300a, and the holding metal plate 234 including the arm 300a lowers to the closed position. Accordingly, the pressing roller 232 is brought close to the transport roller 230, and the pressing roller 232 presses the printed paper 150 toward the transport roller 230. Therefore, the printed paper 150 can be pressed without providing a drive unit that drives the holding metal plate 234, and the looseness in the printed paper 150 can be removed. When the movable blade 222 and the carriage 224 move from the standby position PB to the stop position Pb, the similar state is also realized except that the contact between the carriage 224 and the arm 300b is released.

Passing the printed paper 150 through the pressing mechanism 212 is ensured in both the state where the holding metal plate 234 is at the open position and the state where the holding metal plate 234 is at the closed position. However, in the printer 100, passing the printed paper 150 through the pressing mechanism 212 is performed in the state where the holding metal plate 234 is at the open position, that is, the movable blade 222 and the carriage 224 are at the standby position PA or the standby position PB.

13 Conditions That Movable Blade Must Meet To Hold Printed Paper Before Starting To Cut Printed Paper

In the printer 100, the pressing roller 232 presses the printed paper 150 toward the transport roller 230 before the movable blade 222 starts cutting the printed paper 150. In the following, the conditions to be satisfied for this are described.

The distance Lb that the movable blade 222 and the carriage 224 move when the movable blade 222 and the carriage 224 move from the standby position PA to the stop position Pa is represented by Lb=Mb×Nb using the distance Mb that the movable blade 222 and the carriage 224 move while the rotary shaft of the movable blade drive unit 226 rotates once and the number Nb that the rotary shaft rotates while the movable blade 222 and the carriage 224 move by the distance Lb. Further, the pulse count number Sb counted by the pulse counting unit 274 while the movable blade 222 and the carriage 224 move by the distance Lb is represented by Sb=Nb×Se using the number Nb described above and the number of slits Se of the rotary encoder 270.

The distance La that the movable blade 222 and the carriage 224 move when the movable blade 222 and the carriage 224 move from the standby position PA to the one widthwise end portion Ea of the printed paper 150 is represented by La=Mb×Na using the above distance Mb and the number Na that the rotary shaft rotates while the movable blade 222 and the carriage 224 move by the distance La. Further, the pulse count number Sa counted by the pulse counting unit 274 while the movable blade 222 and the carriage 224 move by the distance La is represented by Sa=Na×Se using the number Na described above and the number of slits Se of the rotary encoder 270.

In order for the pressing mechanism 212 to press the printed paper 150 before the movable blade 222 starts cutting the printed paper 150, Lb<La, that is, Sb<Sa must be satisfied.

When the movable blade 222 and the carriage 224 move from the standby position PA to a position where the contact between the carriage 224 and the arm 300a is released, the moving distance of the movable blade 222 and the carriage 224 is represented by Lc, and Lc<Lb is must be satisfied.

In order for the printed paper 150 to pass through the cutter 210 without contacting the movable blade 222, La-Lb≥Ld, that is, Sa-Sb≥Sd must be satisfied, in which the braking distance required to stop the driven carriage 224 and movable blade 222 is represented by Ld, and the pulse count number counted by the pulse counting unit 274 while the movable blade 222 and the carriage 224 move by the moving distance Ld is represented by Sd. Therefore, the movable blade drive unit 226 must drive the movable blade 222 and the carriage 224 to stop so that La-Lb≥Ld, that is, Sa-Sb≥Sd, is satisfied.

14 Drive of Movable Blade

Based on the width and thickness of the paper 120, and the moving distance detected by the distance sensor (rotation sensor) 260 after the standby position sensor 290a detects that the movable blade 222 is at the standby position PA, the control unit 370 controls the movable blade drive unit 226. The position of the movable blade 222 in the width direction of the printed paper 150 is specified from the moving distance detected by the distance sensor 260 after the standby position sensor 290a detects that the movable blade 222 is at the standby position PA. Accordingly, the movable blade drive unit 226 can generate a driving force that changes according to the width and thickness of the paper 120 and the position of the movable blade 222 in the width direction of the printed paper 150.

In the following, an example is described in which the control of the driving force is performed by controlling the driving torque and the rotation speed of the DC motor provided in the movable blade drive unit 226, and the control of the DC motor driving torque and the rotation speed is controlled by pulse width modulation (PWM) of duty ratio of DC motor driving voltage. However, the control of the driving force may be performed by other methods.

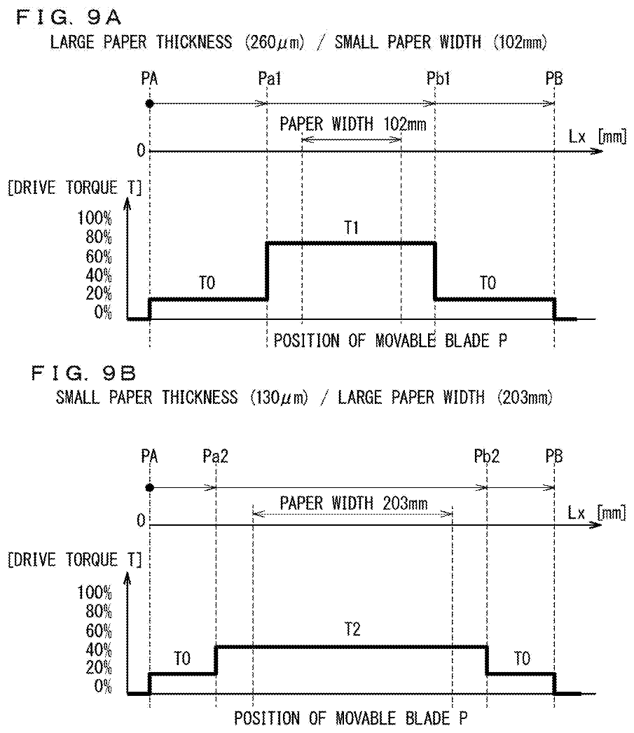

FIGS. 9A and 9B are the graphs illustrating a relationship between a position P of the movable blade included in the printer according to Embodiment 1 in the width direction of the printed paper and the driving torque T generated by the DC motor included in the movable blade drive unit of the printer. FIG. 9A is a graph illustrating the relationship when the thickness of the printed paper is 260 μm and the width of the printed paper is 102 mm. FIG. 9B is a graph illustrating the relationship when the thickness of the printed paper is 130 μm and the width of the printed paper is 203 mm.

When the thickness of the printed paper 150 is 260 μm and the width of the printed paper 150 is 102 mm, as illustrated in FIG. 9A, the movable blade drive unit 226 drives the movable blade 222 and the carriage 224 by the driving torque T0 in a section from the standby position PA to the stop position Pa1 where only the movement of the movable blade 222 and the carriage 224 is performed without cutting the printed paper 150. The driving torque TO is obtained by setting the duty ratio to 20%.

Further, the movable blade drive unit 226 drives the movable blade 222 and the carriage 224 by the driving torque T1 in a section from the stop position Pa1 to the stop position Pb1 in which the cutting of the printed paper 150 is performed. The driving torque T1 is obtained by setting the duty ratio to 80%. The driving torque T1 is larger than the driving torque TO in order to resist the cutting resistance.

Further, the movable blade drive unit 226 drives the movable blade 222 and the carriage 224 by the driving torque TO in a section from the stop position Pb1 to the standby position PB in which the printed paper 150 is not cut and only the movement of the movable blade 222 and the carriage 224 is performed. The driving torque TO is obtained by setting the duty ratio to 20%.

When the thickness of the printed paper 150 is 130 μm and the width of the printed paper 150 is 203 mm, as illustrated in FIG. 9B, the movable blade drive unit 226 drives the movable blade 222 and the carriage 224 by the driving torque TO in a section from the standby position PA to the stop position Pa2 in which only the movement of the movable blade 222 and the carriage 224 is performed without cutting the printed paper 150. The driving torque T0 is obtained by setting the duty ratio to 20%.

Further, the movable blade drive unit 226 drives the movable blade 222 and the carriage 224 by the driving torque T2 in a section from the stop position Pa2 to the stop position Pb2 in which the cutting of the printed paper 150 is performed. The driving torque T2 is obtained by setting the duty ratio to 50%. The driving torque T2 is larger than the driving torque T0 in order to resist the cutting resistance. The driving torque T2 is smaller than the driving torque T1 because the cutting resistance becomes smaller as the thickness of the printed paper 150 becomes thinner.

Further, the movable blade drive unit 226 drives the movable blade 222 and the carriage 224 by the driving torque T0 in a section from the stop position Pb2 to the standby position PB in which the printed paper 150 is not cut and only the movement of the movable blade 222 and the carriage 224 is performed. The driving torque T0 is obtained by setting the duty ratio to 20%.

In the printer 100, based on the width and thickness of the paper 120 and the detection results of the standby position sensor 290a and the distance sensor 260, the driving force that changes according to the width and thickness of the paper 120 and the position of the movable blade 222 in the width direction of the printed paper 150 is generated. Therefore, generation of a driving force suitable for the width and thickness of the printed paper 150 is ensured without providing a large number of position sensors. Accordingly, a printer 100 having a simple structure, which is low in cost, and capable of shortening of the cutting time and suppressing the fluctuations in cutting time, can be provided. Accordingly, the printer 100 having a simple structure, which is low in cost, and capable of shortening of the cutting time, and improving the cutting accuracy of the printed paper 150 and improving the quality of an output printed object can be provided.

For example, in the printer 100, after the standby position sensor 290a detects that the movable blade 222 is at the standby position PA, the position of the movable blade 222 and the position of the carriage 224 in the width direction of the printed paper 150 are specified from the moving distance detected by the distance sensor 260. Therefore, even when the width of the printed paper 150 is changed, the movable blade 222 and the carriage 224 can be stopped at the stop position Pa in front of the one widthwise end portion Ea of the printed paper 150 and the stop position Pb in front of the other widthwise end portion Eb of the printed paper 150.

Further, in the printer 100, after the standby position sensor 290a detects that the movable blade 222 is at the standby position PA. the position of the movable blade 222 and the position of the carriage 224 in the width direction of the printed paper 150 are specified from the moving distance detected by the distance sensor 260. Therefore, when the width of the cutter 210 or the width of the paper 120 is changed, the position sensor is not necessary to be moved according to the width of the cutter 210 or the width of the paper 120, and an additional position sensor is not required to be provided according to the width of the cutter 210 or the width of the paper 120. Accordingly, a plurality of sheets of paper 120 each having a plurality of different widths are dealt at low cost without moving the position sensor or providing an additional position sensor.

Further, when the movable blade 222 and the carriage 224 are controlled based on the moving time of the movable blade 222 and the carriage 224 when the braking distance varies, the stop positions of the movable blade 222 and the carriage 224 also vary. Nevertheless, in the printer 100, after the standby position sensor 290a detects that the movable blade 222 is at the standby position PA, the position of the movable blade 222 and the position of the carriage 224 in the width direction of the printed paper 150 can be specified from the moving distance detected by the distance sensor 260. Therefore, even when the driving force varies, the accuracy of the stop positions of the movable blade 222 and the carriage 224 can be secured.

Further, in the printer 100, after the standby position sensor 290a detects that the movable blade 222 is at the standby position PA, the position of the movable blade 222 and the position of the carriage 224 in the width direction of the printed paper 150 can be specified from the moving distance detected by the distance sensor 260. Therefore, the movable blade 222 can be brought close to the one widthwise end portion Ea or the other widthwise end portion Eb of the printed paper 150 before the cutting of the printed paper 150 is started, and thus the cutting time of the printed paper 150 can be shortened.

Further, when the driving force corresponding to the position of the movable blade 222 in the width direction of the printed paper 150 cannot be generated, both stoppage of the movable blade 222 and the carriage 224 and cutting of the printed paper 150 may not be performed appropriately in some cases. For example, when the printed paper 150 is thick paper such as a card board having a thickness of 260 μm or more, and a DC motor that generates a large torque necessary for cutting the printed paper 150 is provided, the printed paper 150 may possibly be cut appropriately, however, the movable blade 222 and carriage 224 may not be stopped appropriately. The movable blade 222 and the carriage 224 may not be appropriately stopped when a DC motor that generates a large torque is provided. This is because the rotation speed becomes excessively fast, and the movable blade 222 and the carriage 224 may not be able to be appropriately stopped between the standby position PA and the one widthwise end portion Ea of the printed paper 150. However, in the printer 100, the control of the driving force is performed by the control by the pulse width modulation (PWM) of the duty ratio of the driving voltage of the DC motor, and the driving force can be generated according to the position of the movable blade 222 in the width direction of the printed paper 150. Therefore, both stoppage of the movable blade 222 and the carriage 224 and cutting of the printed paper 150 can be performed appropriately. For example, the movable blade 222 and the carriage 224 are appropriately stopped by setting the duty ratio to 30% until the stoppage of the movable blade 222 and the carriage 224, and by setting the duty ratio to 90% while the printed paper 150 is being cut, the printed paper 150 can be cut appropriately.

The driving force may be changed while the printed paper 150 is being cut. For example, when the quality of the cut surface improves as the cutting speed becomes slower, the driving force may be changed such that the cutting speed is adjusted in a manner that the cutting speed becomes slower in the section in which the effect of improving the quality of the cut surface is remarkable and the cutting speed becomes faster in the remaining section. Specifically, the duty ratio is set to 40% immediately after the cutting of the printed paper 150 is started and immediately before the cutting of the printed paper 150 is finished, and apart from that, the duty ratio is set to 80%, thereby, while suppressing an increase in the cutting time, the cutting portion of the printed paper 150 is suppressed from becoming slanted in the vicinity of the one widthwise end portion Ea and the other widthwise end portion Eb, improvement in cutting accuracy and outputting a printed object having high quality is ensured. Such a change in the driving force can be executed, regardless of the width of the printed paper 150, with the capability of grasping the relationship among the one widthwise end portion Ea, the other widthwise end portion Eb of the printed paper 150 and the position of the movable blade 222 in the width direction of the printed paper 150.

15 Overall Operation of Printer

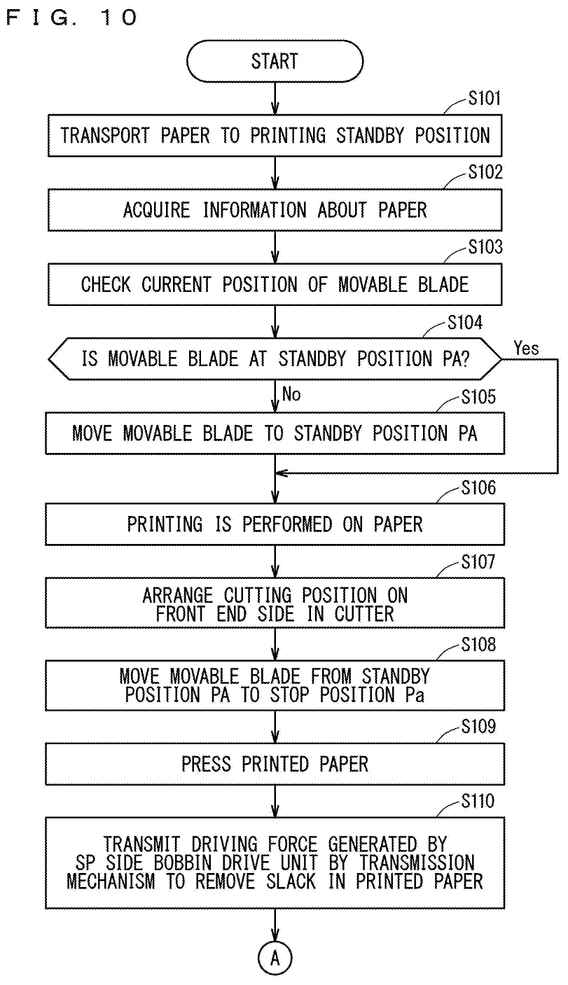

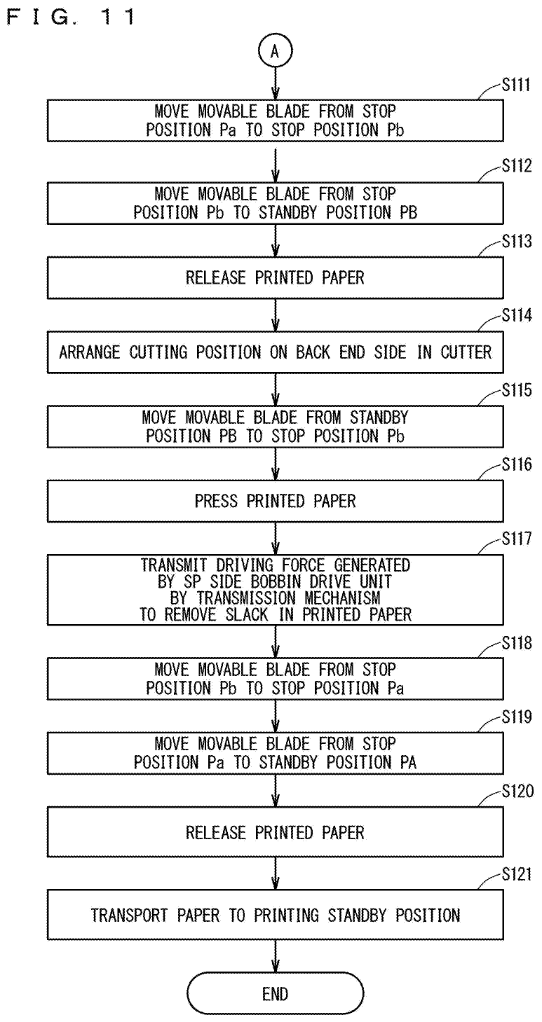

FIG. 10 and FIG. 11 are a flowchart illustrating the flow of the overall operation of the printer according to Embodiment 1. The overall operation illustrated in FIG. 10 and FIG. 11 includes an operation of removing the looseness in the printed paper and an operation of outputting a printed object.

In Step S101 illustrated in FIG. 10, the printer 100 starts printing. When printing is started, first, the rolled paper rotation drive unit 190 drives the roll of paper 110 to rotate. Accordingly, the paper 120 is transported to the main transport roller 192 and fed to the main transport roller 192. Further, the main transport roller 192 transports the fed paper 120 to the printing standby position.

In Step S102, the control unit 370 acquires information about the paper 120 from the memory 362. The acquired information includes the thickness and width of the paper 120.

In Step S103, the control unit 370 acquires a detection result of the standby position sensor 290a and checks the current positions of the movable blade 222 and the carriage 224. Thereby, whether or not the movable blade 222 and the carriage 224 are at the standby position PA can be confirmed.

In Step S104, the control unit 370 determines whether or not the movable blade 222 and the carriage 224 are at the standby position PA based on the acquired detection result. When the movable blade 222 and the carriage 224 are not at the standby position PA, the control unit 370 proceeds with the processing to Step S106 through Step S105, and when the movable blade 222 and the carriage 224 are at the standby position PA, the control unit 370 proceeds with the processing to Step S106 without passing through Step S105.

When the movable blade 222 and the carriage 224 are not at the standby position PA, the control unit 370 controls the movable blade drive unit 226 to cause the movable blade drive unit 226 to move the movable blade 222 and the carriage 224 to the standby position PA in Step S105.

The state in which the movable blade 222 and the carriage 224 are at the standby position PA is realized by Steps S104 and S105, and a state in which, from the moving distance detected by the distance sensor 260, the positions of the movable blade 222 and the carriage 224 in the width direction of the printed paper 150 can be specified is ready.

In Step S106, the thermal head 200 heats the ink sheet 130. As a result, the Y, M, and C ink dyes and the OP material are thermally transferred from the ink sheet 130 to the paper 120, printing on the paper 120 is performed, and the printed paper 150 is produced.

In Step S107, the main transport roller 192 transports the printed paper 150 so that the cutting position on the front end side of the printed paper 150 is arranged in the cutter 210.

In Step S108, the control unit 370 controls the movable blade drive unit 226 based on the acquired width of the paper 120. Accordingly, the movable blade drive unit 226 drives the movable blade 222 and the carriage 224 with the set driving torque to move the movable blade 222 and the carriage 224 from the standby position PA to the stop position Pa.

In Step S109, the pressing roller 232 presses the printed paper 150 toward the transport roller 230. Pressing the printed paper 150 toward the transport roller 230 by the pressing roller 232 is executed by releasing the contact between the carriage 224 and the arm 300a while Step S108 is being executed.

In Step S110, the transmission mechanism 236 transmits the driving force generated by the SP side bobbin drive unit 180 to the transport roller 230. As a result, the transport roller 230 is rotationally driven and the looseness in the printed paper 150 is removed.

In Step S111, the control unit 370 controls the movable blade drive unit 226 based on the acquired width of the paper 120. Accordingly, the movable blade drive unit 226 drives the movable blade 222 and the carriage 224 with the set driving torque to move the movable blade 222 and the carriage 224 from the stop position Pa to the stop position Pb. Accordingly, the movable blade 222 traverses the printed paper 150 in the width direction, cuts the printed paper 150, and separates the leading end margin of the printed paper 150 from the printed surface. The printed paper 150 is pressed by the pressing mechanism 212 before the movable blade 222 starts cutting the printed paper 150, and the looseness in the printed paper 150 is removed before the movable blade 222 starts cutting the printed paper 150; therefore, the cutting of the printed paper 150 by the movable blade 222 is performed in a state where the printed paper 150 is pressed and the looseness in the printed paper 150 is removed. Thereby, the accuracy of the cutting position can be improved.

In Step S112, the control unit 370 controls the movable blade drive unit 226. Accordingly, the movable blade drive unit 226 drives the movable blade 222 and the carriage 224 with the set driving torque to move the movable blade 222 and the carriage 224 from the stop position Pb to the standby position PB.

In Step S113, the pressing roller 232 is moved away from the transport roller 230. As a result, the printed paper 150 is released. Moving the pressing roller 232 away from the transport roller 230 is executed by bringing the carriage 224 into close contact with the arm 300b while Step S112 is being executed.

In Step S114, the main transport roller 192 transports the printed paper 150 so that the cutting position on the back end side of the printed paper 150 is arranged in the cutter 210.

In Step S115, the control unit 370 controls the movable blade drive unit 226 based on the acquired width of the paper 120. Accordingly, the movable blade drive unit 226 drives the movable blade 222 and the carriage 224 with the set driving torque to move the movable blade 222 and the carriage 224 from the standby position PB to the stop position Pb.

In Step S116, the pressing roller 232 presses the printed paper 150 toward the transport roller 230. Pressing the printed paper 150 toward the transport roller 230 by the pressing roller 232 is executed by releasing the contact between the carriage 224 and the arm 300b while Step S115 is being executed.

In Step S117, the transmission mechanism 236 transmits the driving force generated by the SP side bobbin drive unit 180 to the transport roller 230. As a result, the transport roller 230 is rotationally driven and the looseness in the printed paper 150 is removed.

In Step S118, the control unit 370 controls the movable blade drive unit 226 based on the acquired width of the paper 120. Accordingly, the movable blade drive unit 226 drives the movable blade 222 and the carriage 224 with the set driving torque to move the movable blade 222 and the carriage 224 from the stop position Pb to the stop position Pa. Accordingly, the movable blade 222 traverses the printed paper 150 in the width direction, cuts the printed paper 150, and separates the rear end margin of the printed paper 150 from the printed surface. The printed paper 150 is pressed by the pressing mechanism 212 before the movable blade 222 starts cutting the printed paper 150, and the looseness in the printed paper 150 is removed before the movable blade 222 starts cutting the printed paper 150; therefore, the cutting of the printed paper 150 by the movable blade 222 is performed in a state where the printed paper 150 is pressed and the looseness in the printed paper 150 is removed. Thereby, the accuracy of the cutting position can be improved.

In Step S119, the control unit 370 controls the movable blade drive unit 226. Accordingly, the movable blade drive unit 226 drives the movable blade 222 and the carriage 224 with the set driving torque to move the movable blade 222 and the carriage 224 from the stop position Pa to the standby position PA.

In Step S120, the pressing roller 232 is moved away from the transport roller 230. As a result, the printed paper 150 is released. Moving the pressing roller 232 away from the transport roller 230 is executed by bringing the carriage 224 into close contact with the arm 300a while Step S119 is being executed.

In Step S121, the main transport roller 192 transports the fed paper 120 to the printing standby position.

16 Modification

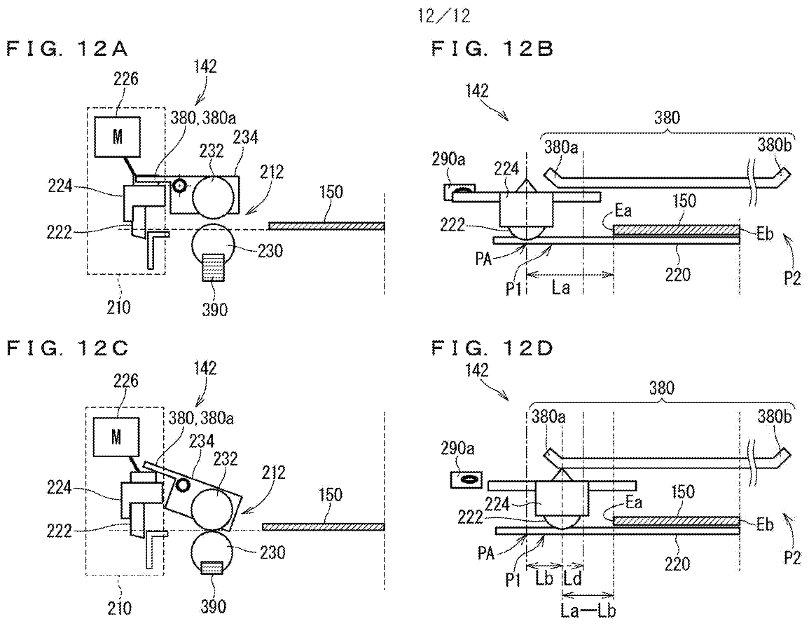

FIGS. 12A to 12D are diagrams schematically illustrating a state in which the cutting mechanism included in the printer according to Modification of Embodiment 1. FIGS. 12A and 12B are diagrams illustrating a state of the main part of the cutting mechanism when the movable blade and the carriage are at the standby position. FIG. 12A is a side view. FIG. 12B is a front view. FIGS. 12C and 12D are diagrams illustrating a state of the main part of the cutting mechanism when the movable blade and the carriage are at the stop position. FIG. 12C is a side view. FIG. 12D is a front view.

In the cutting mechanism 142 illustrated in FIGS. 12A to 12D, the arm 380a provided on the holding metal plate 234 is on a first position P1 between the standby position PA and the one widthwise end portion Ea of the printed paper 150, and extends from above the first position P1 over the printed sheet 150. Further, the arm 380b provided on the holding metal plate 234 is on a second position P2 between the standby position PB (not illustrated in FIGS. 12A to 12D) and the other widthwise end portion Eb of the printed paper 150, and extends from above the second position P2 over the printed paper 150. The arm 380a and the arm 380b are integrally connected to each other over the printed paper 150.

The arm 380a and the arm 380b form a contact portion 380 that contacts the carriage 224 when the movable blade 222 is at the first position P1, the second position P2, or between the first position P1 and the second position P2.

The compression spring 390 provided in the pressing mechanism 212 urges the transport roller 230 in the direction toward the pressing roller 232. The transport roller 230 slightly protrudes toward the pressing roller 232 side from the paper transport path in a state where the transport roller 230 is not pressed by the pressing roller 232. The compression spring 390 may be replaced with an elastic body other than the tension spring. For example, the compression spring 390 may be replaced with a tension spring, a torsion-coil spring, a leaf spring, an air spring, a rubber cord, or the like.

The carriage 224 contacts the contact portion 380 when the movable blade 222 is at the first position P1, the second position P2, or between the first position P1 and the second position P2, and pushes and moves the contact portion 380. The direction in which the contact portion 380 is pushed and moved is the direction in which the movement that the pressing roller 232 is brought close to the transport roller 230 is generated. The pressing roller 232 presses the printed paper 150 toward the transport roller 230 withstanding the force generated by the compression spring 390. Accordingly, the printed paper 150 is pressed by the pressing mechanism 212 when the movable blade 222 and the carriage 224 are at the first position P1, the second position P2, or between the first position P1 and the second position P2, whilst the printed paper 150 is not pressed by the pressing mechanism 212 when the movable blade 222 and the carriage 224 are not in the first position P1, the second position P2, or between the first position P1 and the second position P2.

The shape of the holding metal plate 234 is determined so that the height of the lower end portion of the pressing roller 232 when the pressing roller 232 presses the printed paper 150 toward the transport roller 230 coincides with the height of the paper transport path.

With the arm 380a and the arm 380b, the load when the carriage 224 pushes up the arms 380a and 380b can be used to stop the movable blade 222 and the carriage 224, so that the braking distance Ld can be shortened. Therefore, the width of the cutter 210 can be reduced, the cutter 210 can be downsized, and the cost of the cutter 210 can be reduced.

It should be noted that Embodiment of the present invention can be appropriately modified or omitted without departing from the scope of the invention.

While the invention has been described in detail, the forgoing description is in all aspects illustrative and not restrictive. It is understood that numerous other modifications and variations can be devised without departing from the scope of the invention.

1. A printer comprising:
a bobbin drive unit configured to generate a driving force that rotationally drives a bobbin on which an ink sheet is wound;
a thermal head) configured to heat the ink sheet, perform thermal transfer from the ink sheet to paper delivered from a roll of paper, and produce printed paper;
a fixed blade extending in a width direction of the printed paper;
a movable blade arranged along the fixed blade and configured to move in the width direction and cut the printed paper;
a movable blade drive unit configured to drive the movable blade; and
a pressing mechanism including a transport roller and a pressing roller, wherein the transport roller is rotationally driven by the driving force, the pressing roller presses the printed paper toward the transport roller before the movable blade starts cutting the printed paper, and looseness is removed from the printed paper before the movable blade starts cutting the printed paper.

2. The printer according to claim 1, wherein the pressing mechanism further includes a transmission mechanism configured to transmit the driving force from the bobbin drive unit to the transport roller.

3. The printer according to claim 1, further comprising
a carriage configured to hold the movable blade, wherein
the movable blade drive unit drives the carriage to integrally drive the movable blade and the carriage, and
the pressing mechanism further includes
a holding part configured to hold the pressing roller, and including contact portion that contacts the carriage when the movable blade is at a standby position, and that is pushed and moved in a direction iii which a movement that the pressing roller is moved away from the transport roller is generated.

4. The printer according to claim 1, further comprising
a carriage configured to hold the movable blade, wherein
the movable blade drive unit drives the carriage to integrally drive the movable blade and the carriage, and
the pressing mechanism further includes
a holding part configured to hold the pressing roller, and including a contact portion that contacts the carriage when the movable blade is at a position between a standby position and a widthwise end portion of the printed paper, and that is pushed and moved in a direction in which a movement that brings the pressing roller close to the transport roller is generated.

5. The printer according to any of claims claim 1, wherein
a storage unit configured to store a width and a thickness of the paper;
a standby position sensor configured to detect that the movable blade is at a standby position;
a distance sensor configured to detect a moving distance of the movable blade; and
a control unit configured to control the movable blade drive unit based on the width and the thickness of the paper and the moving distance of the movable blade detected by the distance sensor after the standby position sensor detects that the movable blade is at the standby position, and cause the movable blade drive unit to generate a driving force that changes according to the width and the thickness of the paper, and a position of the movable blade in the width direction.
